(19) United States
(12) Patent Application Publication
(10) Pub. No.: US 2014/0278447 A1
(43) Pub. Date: Sep. 18, 2014

(54) DIGITAL WATERMARK DETECTION DEVICE AND DIGITAL WATERMARK DETECTION METHOD, AS WELL AS TAMPERING DETECTION DEVICE USING DIGITAL WATERMARK AND TAMPERING DETECTION METHOD USING DIGITAL WATERMARK

(71) Applicants: Masashi Unoki, Nomi-shi (JP); Ryota Miyauchi, Nomi-shi (JP); Toshizo Kosugi, Nomi-shi (JP)

(72) Inventors: Masashi Unoki, Nomi-shi (JP); Ryota Miyauchi, Nomi-shi (JP); Toshizo Kosugi, Nomi-shi (JP)

(73) Assignee: Japan Advanced Institute of Science and Technology, Nomi-shi (JP)

(21) Appl. No.: 14/343,676

(22) PCT Filed: Aug. 22, 2012
(86) PCT No.: PCT/JP2012/071202

§ 371 Date: May 22, 2014

(30) Foreign Application Priority Data
Sep. 8, 2011 (JP) 2011-196449
Nov. 1, 2011 (JP) 2011-240692

(51) Int. Cl. G10L 19/018

(52) U.S. Cl. CPC G10L 19/018
USPC 704/500

(57) ABSTRACT

A digital watermark detection device includes a first chirp z-transform unit (202a) and a second chirp z-transform unit (202b) for estimating the cochlear delay characteristics simulated by cochlear delay filters that were used in embedding digital watermark data in an acoustic signal. The digital watermark data embedded in the acoustic signal is detected based on the cochlear delay characteristics estimated in accordance with the result of chirp z-transform applied by these first chirp z-transform unit (202a) and second chirp z-transform unit (202b).

### TECHNICAL FIELD

The present invention relates to a digital watermark detection device and a digital watermark detection method for detecting digital watermark data embedded in an acoustic signal (e.g., speech and music), which is digital data, and to a tampering detection device and a tampering detection method for detecting tampering with an acoustic signal using digital watermark data.

### BACKGROUND ART

Recent dissemination of the Internet and other communication networks has led to provision of, for example, services for distributing digital music contents. However, as digital music contents can be copied almost without degrading the audio quality, illegal copies thereof are widespread, which has become a social issue. In view of this, attention has been directed to digital acoustic watermarking techniques that enable, for example, prevention and tracking of illegal copies by embedding additional information (digital watermark data), such as copyright information and a serial number, in an acoustic signal for the purpose of protecting copyrights for digital music contents.

Examples of digital acoustic watermarking techniques include (1) a method for embedding a watermark in coding/quantization levels, such as an LSB (least significant bit) replacement method (see Non-Patent Document 1), and (2) a method for embedding information in the spread spectrum of an original signal, such as a DSS (direct spread spectrum) method (Non-Patent Document 2). Furthermore, (3) an echo hiding method (hereinafter referred to as “ECHO method”, see Non-Patent Document 3), (4) a PPM (periodical phase modulation) method (see Non-Patent Document 4 and Patent Document 1), and the like have been proposed as methods based on perceptual characteristics associated with phases.

One of the characteristics of human hearing is what is called the CD (cochlear delay) characteristics. When a sound signal propagates inside a cochlea (inside the incompressible lymph in the scala vestibuli and the scala tympani), vibrations of (propagations along) the basilar membrane of the cochlea caused by a pressure difference between the scala vestibuli and the scala tympani show some time differences depending on signal frequencies. This phenomenon is cochlear delay. It is known that the lower the frequency of a sound signal, the larger the delay.

Non-Patent Document 5 discusses a relationship between the aforementioned cochlear delay and judgment of sound synchrony. More specifically, Non-Patent Document 5 describes an auditory psychophysical experiment that was conducted using the following three complex sounds: (a) a normal harmonic complex sound (with no manipulation of cochlear delay), (b) a harmonic complex sound introduced with group delay that cancels out cochlear delay in the basilar membrane of the cochlea, and (c) a harmonic complex sound introduced with group delay that enhances cochlear delay. Non-Patent Document 5 discusses how the cochlear delay affects judgment of sound synchrony based on the result of the experiment. Non-Patent Document 5 reveals that the use of the complex sound (c) allows synchrony judgment that is more similar to synchrony judgment achieved with the complex sound (a) than the use of the complex sound (b).

Focusing on the aforementioned cochlear delay characteristics, Non-Patent Document 6 and Non-Patent Document 7 propose a method for realizing a digital acoustic watermark by applying, to an original signal, two different types of delay patterns that resemble the cochlear delay and correspond to binary data of information to be embedded as a digital watermark (hereinafter referred to “CD method”).

### CITATION LIST

### Patent Documents

Patent Document 1: JP 3627022B

### Non-Patent Documents

Non-Patent Document 1: N. Cvejic and T. Seppanen, “Digital audio watermarking techniques and technologies”, IGI Global, 2007
Non-Patent Document 2: Boney, L., Tewfik, H. H., and Hamdy, K. N., “Digital watermarks for audio signals”, Proc. ICMCS, 473-480, 1996
Non-Patent Document 3: Daniel Gruhl, Anthony LuWalter Bender, “Echo Hiding”, Proc. Information Hiding 1st Workshop, pp. 295-315, Cambridge Univ., 1996
Non-Patent Document 4: Ryoichi Nishimura and Yoiti Suzuki, “Audio watermark based on periodical phase shift”, J. Acoust. Soc. Jpn., vol. 60, no. 5, pp. 269-272, 2004
Non-Patent Document 5: E. Aiba, S. Tanaka, M. Tsuzaki, and M. Unoki, “Judgment of perceptual synchrony between two pulses and its relation to the cochlear delays”, Proc. Fechner day 2007, 211-214, 2007
Non-Patent Document 6: Unoki, M. and Hamada, D. “Audio watermarking method based on the cochlear delay characteristics”, Proc. IIHMSP2008, 616-619, 2008
Non-Patent Document 7: Unoki, M. and Hamada, D. “Method of digital-audio watermarking based on cochlear delay characteristics”, Int. J. Innv. Comp., Inf. Cont., 6 (3(B)), 1325-1346, 2010

### SUMMARY OF INVENTION

### Problem to be Solved by the Invention

In general, digital acoustic watermarking techniques are expected to satisfy the following requirements: imperceptibility (a user is not able to perceive embedded information, and embedding does not cause perceptible distortion of an original signal), robustness (not affected by normal signal transformation processing and by malicious attacks, such as deletion of embedded information), and confidentiality (embedding of information is not able to be noticed, and even if noticed, embedded information is not easily detected).

The aforementioned LSB method (1) satisfies the imperceptibility requirement as it embeds information in least significant bits, which do not significantly affect amplitude information. However, it is sensitive to changes in bits, and hence has a drawback in terms of robustness. The aforementioned DSS method (2) is robust against signal transformation processing as it embeds information in the entirety of the spectrum. However, it allows embedded information to be easily perceived, and hence has a drawback in terms of imperceptibility.

The aforementioned ECHO method (3) can realize distortion-free, imperceptible embedding by adjusting the echo duration and the amplitude of a primary reflected sound. However, it allows watermark information to be easily detected and removed using an autocorrelation method and cepstrum processing, and is hence the least robust and confidential method of all the aforementioned conventional methods. The aforementioned PPM method (4), which is based on auditory characteristics whereby periodical phase modulation is relatively difficult to perceive, has a drawback in terms of imperceptibility because phase modulation randomly distorts the phase spectra of high-frequency components.

On the other hand, while the aforementioned CD method sufficiently satisfies the imperceptibility, confidentiality and robustness requirements, it requires that an original signal be referred to in order to detect embedded information, thereby giving rise to the problem that the range of application is restricted.

The present invention has been made in view of the above issues. A primary object of the present invention is to provide a digital watermark detection device and a digital watermark detection method that can detect information embedded using a CD method without referring to an original signal. Another object of the present invention is to provide a tampering detection device and a tampering detection method that make use of a digital acoustic watermarking technique.

### Means for Solving Problem

In order to solve the above problems, a digital watermark detection device according to one aspect of the present invention includes: a cochlear delay characteristics estimation means for estimating cochlear delay characteristics simulated by a cochlear delay filter in a case where a digital watermark data embedding device has embedded digital watermark data in an acoustic signal, which is digital data, the digital watermark data embedding device applying phase modulation to the acoustic signal using the cochlear delay filter that simulates the cochlear delay characteristics and embedding the digital watermark data in the acoustic signal to which phase modulation has been applied; and a digital watermark detection means for detecting the digital watermark data embedded in the acoustic signal based on the cochlear delay characteristics estimated by the cochlear delay characteristics estimation means.

In this aspect, the digital watermark data embedding device may be configured to embed the digital watermark data by generating a plurality of different phase-modulated acoustic signals through application of phase modulation to acoustic signals using a plurality of different cochlear delay filters, selecting one acoustic signal from among the plurality of different phase-modulated acoustic signals in accordance with the digital watermark data, and merging selected acoustic signals. Also, the cochlear delay characteristics estimation means may be configured to estimate a plurality of different cochlear delay characteristics simulated respectively by the plurality of different cochlear delay filters. In addition, the digital watermark detection means may be configured to detect the digital watermark data by determining which one of the plurality of different cochlear delay filters has been used to apply phase modulation to the acoustic signals that have been embedded with the digital watermark data based on the plurality of different cochlear delay characteristics estimated by the cochlear delay characteristics estimation means.

Furthermore, in the above aspect, the cochlear delay characteristics estimation means may be configured to estimate the cochlear delay characteristics by estimating a zero of the cochlear delay filter.

Furthermore, in the above aspect, the cochlear delay characteristics estimation means may be configured to estimate the zero of the cochlear delay filter using chirp z-transform.

Furthermore, in the above aspect, an original signal acquisition means may be further included for acquiring the acoustic signal that has not been embedded with the digital watermark data yet by applying, to the acoustic signal that has been embedded with the digital watermark data, a filter having characteristics that are the inverse of the cochlear delay characteristics estimated by the cochlear delay characteristics means.

Furthermore, in the above aspect, an original signal acquisition means may be further included for acquiring the acoustic signal that has not been embedded with the digital watermark data yet by applying an inverse filter for the cochlear delay filter that has been determined by the digital watermark detection means to have been used to apply phase modulation to the acoustic signal that has been embedded with the digital watermark data, to that acoustic signal that has been embedded with the digital watermark data.

A digital watermark detection method according to one aspect of the present invention includes: (a) a step of estimating cochlear delay characteristics simulated by a cochlear delay filter in a case where a digital watermark data embedding device has embedded digital watermark data in an acoustic signal, which is digital data, the digital watermark data embedding device applying phase modulation to the acoustic signal using the cochlear delay filter that simulates the cochlear delay characteristics and embedding the digital watermark data in the acoustic signal to which phase modulation has been applied; and (b) a step of detecting the digital watermark data embedded in the acoustic signal based on the estimated cochlear delay characteristics.

In the above aspect, the digital watermark data embedding device may be configured to embed the digital watermark data by generating a plurality of different phase-modulated acoustic signals through application of phase modulation to acoustic signals using a plurality of different cochlear delay filters, selecting one acoustic signal from among the plurality of different phase-modulated acoustic signals in accordance with the digital watermark data, and merging selected acoustic signals. Also, in step (a), a plurality of different cochlear delay characteristics simulated respectively by the plurality of different cochlear delay filters may be estimated. In addition, in step (b), the digital watermark data may be detected by determining which one of the plurality of different cochlear delay filters has been used to apply phase modulation to the acoustic signals that have been embedded with the digital watermark data based on the plurality of different cochlear delay characteristics estimated in step (a).

Furthermore, in the above aspect, the cochlear delay characteristics may be estimated by estimating a zero of the cochlear delay filter in step (a).

Furthermore, in the above aspect, the zero of the cochlear delay filter may be estimated using chirp z-transform in step (a).

A tampering detection device according to one aspect of the present invention makes use of a digital watermark. The tampering detection device detects tampering with an acoustic signal, which is digital data, after digital watermark data has been embedded in the acoustic signal by applying phase modulation to the acoustic signal using a cochlear delay filter that simulates cochlear delay characteristics, and includes: an acoustic signal acquisition means for acquiring the acoustic signal from outside; a cochlear delay characteristics estimation means for estimating the cochlear delay characteristics simulated by the cochlear delay filter; an embedded data detection means for detecting embedded data that has been embedded in the acoustic signal acquired by the acoustic acquisition means based on the cochlear delay characteristics estimated by the cochlear delay characteristics estimation means; a comparison means for comparing the embedded data detected by the embedded data detection means with the digital watermark data; and a tampering determination means for determining whether or not the acoustic signal has been tampered with based on a result of comparison by the comparison means.

A tampering detection method according to one aspect of the present invention makes use of a digital watermark. The tampering detection method detects tampering with an acoustic signal, which is digital data, after digital watermark data has been embedded in the acoustic signal by applying phase modulation to the acoustic signal using a cochlear delay filter that simulates cochlear delay characteristics, and includes: (a) a step of acquiring the acoustic signal from outside; (b) a step of estimating the cochlear delay characteristics simulated by the cochlear delay filter; (c) a step of detecting embedded data that has been embedded in the acquired acoustic signal based on the estimated cochlear delay characteristics; (d) a step of comparing the detected embedded data with the digital watermark data; and (e) a step of determining whether or not the acoustic signal has been tampered with based on a result of comparison.

### Effect of the Invention

A digital watermark detection device and a digital watermark detection method according to the present invention enable detection of digital watermark data that has been embedded using a CD method without referring to an original signal. Furthermore, a tampering detection method and a tampering detection device according to the present invention, which make use of a digital watermark, enable accurate detection of tampering with an acoustic signal.

### BRIEF DESCRIPTION OF DRAWINGS

FIG. 1 is a block diagram showing a configuration of a digital watermark embedding device according to an embodiment of the present invention.

FIG. 2 is a functional block diagram showing a configuration of a digital watermark embedding device according to an embodiment of the present invention.

FIG. 3 is a graph showing characteristics of cochlear delay filters included in a digital watermark embedding device according to an embodiment of the present invention.

FIG. 4 is a block diagram showing a configuration of a digital watermark detection device according to an embodiment of the present invention.

FIG. 5 is a functional block diagram showing a configuration of a digital watermark detection device according to an embodiment of the present invention.

FIG. 6 is a graph illustrating poles and zeroes of cochlear delay filters.

FIGS. 7A to 7I are graphs showing the results of frequency analysis through chirp z-transform.

FIG. 8 is a flowchart showing a procedure of digital watermark embedding processing executed by a digital watermark embedding device in an embodiment of the present invention.

FIG. 9 is a flowchart showing a procedure of digital watermark detection processing executed by a digital watermark detection device in an embodiment of the present invention.

FIGS. 10A to 10C are graphs showing the results of an objective evaluation experiment.

FIG. 11 is a flowchart showing a procedure of original signal acquisition processing executed by a digital watermark detection device in an embodiment of the present invention.

FIGS. 12A to 12C are graphs showing the results of an objective evaluation experiment for a watermarked acoustic signal.

FIGS. 13A to 13C are graphs showing the results of an objective evaluation experiment obtained before and after digital watermark data is deleted through original signal acquisition processing according to an embodiment of the present invention.

FIG. 14 is an explanatory drawing showing an outline of a tampering detection system according to a second embodiment of the present invention.

FIG. 15 is a block diagram showing a configuration of a tampering detection device according to the second embodiment of the present invention.

FIG. 16 is a functional block diagram showing a configuration of the tampering detection device according to the second embodiment of the present invention.

FIG. 17 is a functional block diagram showing a configuration of the tampering detection device according to the second embodiment of the present invention.

FIG. 18 is a flowchart showing a procedure of embedded data detection processing executed by the tampering detection device in the second embodiment of the present invention.

FIG. 19 is a flowchart showing a procedure of tampering determination processing executed by the tampering detection device in the second embodiment of the present invention.

FIG. 20 is a functional block diagram showing the configurations of a digital watermark embedding device and a tampering detection device according to a third embodiment.

FIG. 21 is a flowchart showing a procedure of digital watermark embedding processing executed by the digital watermark embedding device in the third embodiment.

FIG. 22 is a functional block diagram showing a configuration of the digital watermark embedding device according to the third embodiment.

FIG. 23 is a flowchart showing a procedure of embedded data detection processing (non-blind detection).

FIG. 24 is a functional block diagram showing a configuration of the tampering detection device according to the third embodiment.

FIGS. 25A to 25C are graphs showing the results of an objective evaluation experiment.

FIGS. 26A to 26C are graphs showing the results of an robustness evaluation experiment.

FIG. 27 shows an example of a bitmap image used as digital watermark data.

FIGS. 28A to 28E show bitmap images detected in the case where acoustic signals have not been tampered with.

FIGS. 29A to 29E show bitmap images detected in the case where audio coding according to PCM (G.711) has been applied to acoustic signals.

FIGS. 30A to 30E show bitmap images detected in the case where white noise of a low SNR has been applied to acoustic signals.

FIGS. 31A to 31E show bitmap images detected in the case where artificial reverberation has been applied to acoustic signals.

FIGS. 32A to 32E show bitmap images detected in the case where reverberation from a real environment has been applied to acoustic signals.

FIGS. 33A to 33E show bitmap images detected in the case where acoustic signals have been modified using a wavelet-type speech analysis/synthesis system.

FIGS. 34A to 34E show bitmap images detected in the case where acoustic signals have been modified using a speech analysis/synthesis system that takes advantage of a short-time Fourier transform pair.

FIGS. 35A to 35E show bitmap images detected in the case where the contents of acoustic signals have been modified through phonemic piece synthesis.

FIGS. 36A to 36C show a waveform of an acoustic signal, a spectral difference for bit values 0 and 1, and detected values for the case of information-replaced tampering.

FIG. 37 is a flowchart showing a procedure of tampering type determination processing executed by a tampering detection device.

### DESCRIPTION OF EMBODIMENTS

The following describes preferred embodiments of the present invention with reference to the drawings. It should be noted that the following embodiments describe examples of methods and devices for embodying the technical ideas of the present invention, and are not intended to limit the technical ideas of the present invention. Various modifications may be made to the technical ideas of the present invention within a technical scope described in the claims.

### First Embodiment

A digital watermark detection device according to the present embodiment can detect digital watermark data embedded in an original signal without referring to the original signal. In the present description, such detection of digital watermark data without referring to an original signal is called “blind detection”. A description is now given of this digital watermark detection device, as well as a digital watermark embedding device for embedding digital watermark data.

### [Configuration of Digital Watermark Embedding Device]

FIG. 1 is a block diagram showing a configuration of a digital watermark embedding device according to an embodiment of the present invention. As shown in FIG. 1, a digital watermark embedding device 1 includes a CPU 11, a ROM 12, a RAM 13, a signal input unit 14, a signal output unit 15, and a hard disk drive 16. These CPU 11, ROM 12, RAM 13, signal input unit 14, signal output unit 15, and hard disk drive 16 are connected by a bus 17.

The CPU 11 executes computer programs stored in the ROM 12 and the hard disk drive 16. As a result, the digital watermark embedding device 1 executes later-described operations for embedding digital watermark data in an acoustic signal.

The ROM 12 is constituted by, for example, a mask ROM, a PROM, an EPROM, or an EEPROM, and stores computer programs executed by the CPU 11, data used therefor, and the like.

The RAM 13 is constituted by, for example, an SRAM or a DRAM, and is used in reading programs stored in the hard disk drive 16. The RAM 13 is also used as a working area for the CPU 11 when the CPU 11 executes computer programs.

The signal input unit 14 receives, as input, an acoustic signal serving as an original signal targeted for processing as well as digital watermark data to be embedded in the acoustic signal from an external device. The signal output unit 15 outputs the acoustic signal in which the digital watermark data has been embedded (hereinafter referred to as “watermarked acoustic signal”) to an external device.

In the present embodiment, the acoustic signal serving as the original signal is digital data. Alternatively, the acoustic signal may be analog data. In this case, it is sufficient that the signal input unit 14 be provided with an A/D conversion function so that it converts the input acoustic signal into digital data through A/D conversion and provides the digital data for subsequent processing.

In the hard disk drive 16 are installed an operating system, application programs, various computer programs to be executed by the CPU 11, data used in executing these computer programs, and the like. These computer programs include a digital watermark embedding program 16A for embedding digital watermark data.

The digital watermark embedding program 16A, which is installed in the hard disk drive 16, is read from a portable recording medium via an external storage device (not shown in the drawings), such as a flexible disk drive, a CD-ROM drive and a DVD-ROM drive.

Note that the digital watermark embedding program 16A is not limited to being provided from a portable recording medium as described above. The digital watermark embedding program 16A may be provided from an external device that is connected to and can communicate with the digital watermark embedding device 1 via an electric telecommunication line (either wired or wireless). For example, in the case where the digital watermark embedding program 16A is stored in a hard disk drive of a server computer connected to the Internet, this computer program may be installed in the hard disk drive 16 by the digital watermark embedding device 1 accessing the server computer and downloading this computer program.

A multitasking operating system, such as Windows (registered trademark) manufactured and distributed by Microsoft Corporation of the United States, is installed in the hard disk drive 16. It will be assumed that the digital watermark embedding program 16A according to the present embodiment runs on this operating system.

A configuration of the aforementioned digital watermark embedding device 1 will now be described with reference to a functional block diagram of FIG. 2. In the following description, n denotes a sample index, and k denotes a frame index of an acoustic signal.

As shown in FIG. 2, the digital watermark embedding device 1 includes a frame processing unit 101, two cochlear delay filters 102a and 102b, and a filter selection unit 103. The frame processing unit 101 divides an acoustic signal x(n) into frames. The filter selection unit 103 selects one of the first cochlear delay filter 102a and the second cochlear delay filter 102b in accordance with a value of digital watermark data s(k).

Specifically, the filter selection unit 103 selects the first cochlear delay filter 102a if a bit value of the digital watermark data is “0”, and selects the second cochlear delay filter 102b if a bit value of the digital watermark data is “1”. The first cochlear delay filter 102a and the second cochlear delay filter 102b introduce group delay in acoustic signals as will be described later. Once group delay has thus been introduced in acoustic signals, the acoustic signals are integrated. As a result, a watermarked acoustic signal y(n), which is an acoustic signal embedded with digital watermark data, is generated.

Note that in the present embodiment, these frame processing unit 101, first cochlear delay filter 102a, second cochlear delay filter 102b, and filter selection unit 103 are realized by the CPU 11 executing the digital watermark embedding program 16A.

### [Cochlear Delay Filters]

Specifics of the first cochlear delay filter 102a and the second cochlear delay filter 102b will now be described. These first cochlear delay filter 102a and second cochlear delay filter 102b are digital filters that simulate the cochlear delay characteristics of human hearing. More specifically, they are constituted by all-pass filters that change only the phase characteristics without affecting the amplitude components.

In the present embodiment, the cochlear delay filters 102a and 102b are constituted by first-order infinite impulse response all-pass filters defined by a transfer function H(z) represented by the following equation (1).

$$\begin{matrix}[ Equation 1 ] & \\ {H}_{m} ( z ) = \frac{- {b}_{m} + {z}^{- 1}}{1 - {b}_{m} {z}^{- 1}} , m = 0 , 1 & ( 1 )\end{matrix}$$

Here, bₘ denotes a filter coefficient of Hₘ(z).

High-speed processing is enabled by thus constituting the first cochlear delay filter 102a and the second cochlear delay filter 102b with first-order infinite impulse response all-pass filters.

As long as the group delay characteristics of the infinite impulse response all-pass filters accurately represent the cochlear delay characteristics, the filters may be first-order or higher-order filters, and the number of cascading stages for the filters may be one or more.

Group delay τm(ω) introduced by the first cochlear delay filter 102a and the second cochlear delay filter 102b is calculated using the following equation (2).

$$\begin{matrix}[ Equation 2 ] & \\ {τ}_{m} ( ω ) = - \frac{d arg ( {H}_{m} ( {e}^{jω} ) )}{d ω} & ( 2 )\end{matrix}$$

FIG. 3 is a graph showing the characteristics of the first cochlear delay filter 102a and the second cochlear delay filter 102b included in the digital watermark embedding device 1 according to the first embodiment of the present invention. In FIG. 3, a vertical axis indicates group delay, while a horizontal axis indicates the frequency of an acoustic signal.

Also, in FIG. 3, a thin solid line indicates the cochlear delay characteristics scaled to 1/10 of the cochlear delay of human hearing. Furthermore, a thick solid line indicates the characteristics of the first cochlear delay filter 102a defined by the above equation (1) in the case where the filter coefficient b is 0.795, and a dashed line indicates the characteristics of the second cochlear delay filter 102b similarly defined by the above equation (1) in the case where the filter coefficient b is 0.865.

Note that the cochlear delay characteristics indicated by the thin solid line in FIG. 3 is determined with reference to T. Dau, O. Wegner, V Mellert, and B. Kollmeier, “Auditory brainstem responses (ABR) with optimized chirp signals compensating basilar membrane dispersion”, J. Acoust. Soc. Am., 107, 1530-1540, 2000.

Therefore, by applying the first cochlear delay filter 102a and the second cochlear delay filter 102b to an acoustic signal, cochlear delay scaled to 1/10 of the actual cochlear delay is introduced in the acoustic signal. Therefore, in order to approximate the actual human cochlear delay characteristics, these cochlear delay filters need to be connected to have ten cascading stages. However, if cochlear delay of an amount equivalent to the amount of the actual cochlear delay is introduced in the acoustic signal, then the resultant amount of group delay will be twice as large as the amount of the actual cochlear delay when the acoustic signal is perceived. Such delay is considered to be too large. This is why cochlear delay scaled to 1/10 of the actual cochlear delay is introduced in the acoustic signal in the present embodiment as mentioned earlier.

In the present embodiment, the first cochlear delay filter 102a and the second cochlear delay filter 102b acquire intermediate signals w₀(n) and w₁(n), respectively, by applying cochlear delay patterns to the acoustic signal x(n) serving as the original signal in accordance with the following equations (3) and (4). Then, the watermarked acoustic signal y(n) represented by the following equation (5) is acquired by the filter selection unit 103 selecting and merging the intermediate signals w₀(n) and w₁(n) on a per-frame basis in accordance with a bit value of digital watermark data.

$$\begin{matrix}[ Equation 3 ] & \\ {w}_{0} ( n ) = - {b}_{0} x ( n ) + x ( n - 1 ) + {b}_{0} {w}_{0} ( n - 1 ) & ( 3 ) \\ {w}_{1} ( n ) = - {b}_{1} x ( n ) + x ( n - 1 ) + {b}_{1} {w}_{1} ( n - 1 ) & ( 4 ) \\ y ( n ) = \{ \begin{matrix}{w}_{0} ( n ) , & s ( k ) = 0 \\ {w}_{1} ( n ) , & s ( k ) = 1\end{matrix} & ( 5 )\end{matrix}$$

where (k−1)ΔW<n≦kΔW. Here, ΔW(=fₛ/N_{bit}) denotes a frame length, fₛ denotes the sampling frequency of the original signal, and N_{bit} denotes a bit rate per second for embedding information.

### [Configuration of Digital Watermark Detection Device]

FIG. 4 is a block diagram showing a configuration of a digital watermark detection device according to an embodiment of the present invention. As shown in FIG. 4, similarly to the aforementioned digital watermark embedding device 1, a digital watermark detection device 2 includes a CPU 21, a ROM 22, a RAM 23, a signal input unit 24, and a hard disk drive 25. These CPU 21, ROM 22, RAM 23, signal input unit 24, and hard disk drive 25 are connected by a bus 26.

The CPU 21, the ROM 22 and the RAM 23 are similar to the CPU 11, the ROM 12 and the RAM 13 included in the digital watermark embedding device 1, respectively, and therefore a description thereof is omitted.

The signal input unit 24 receives, as input, a watermarked acoustic signal from an external device. This watermarked acoustic signal may be input to the signal input unit 24 directly from the digital watermark embedding device 1 or via another device and/or a communication network and the like.

An operating system, various computer programs to be executed by the CPU 21, and the like are installed in the hard disk drive 25, similarly to the case of the digital watermark embedding device 1. These computer programs include a digital watermark detection program 25A for detecting digital watermark data.

The digital watermark detection program 25A, which installed in the hard disk drive 25, may be provided from a portable recording medium or via an electric communication line, similarly to the case of the digital watermark embedding program 16A. It will be assumed that this digital watermark detection program 25A runs on the operating system installed in the hard disk drive 25, similarly to the case of the digital watermark embedding program 16A.

The following describes a configuration of the aforementioned digital watermark detection device 2 with reference to a functional block diagram of FIG. 5.

As shown in FIG. 5, the digital watermark detection device 2 includes a frame processing unit 201, two chirp z-transform units 202a and 202b, and a bit value detection unit 203. The frame processing unit 201 divides a watermarked acoustic signal y(n) generated by the digital watermark embedding device 1 into frames. The chirp z-transform units 202a and 202b apply chirp z-transform to the watermarked acoustic signal y(n) divided into frames. The bit value detection unit 203 detects a bit value of the digital watermark data based on the result of chirp z-transform applied by the first chirp z-transform unit 202a and the second chirp z-transform unit 202b. Note that in the present embodiment, these frame processing unit 201, first chirp z-transform unit 202a, second chirp z-transform unit 202b, and bit value detection unit 203 are realized by the CPU 21 executing the digital watermark detection program 25A.

### [Chirp Z-Transform]

The chirp z-transform (CZT) applied by the first chirp z-transform unit 202a and the second chirp z-transform unit 202b is known as a method that enables flexible analysis of frequency spectra (for example, see Wang, T. T. “The segmented chirp z-transform and its application in spectrum analysis”, IEEE Trans. Instrumentation and measurement, 39(2), 318-323, 1990), and is utilized in implementation of fast Fourier transform (DFT). The characteristics of this chirp z-transform are such that, compared to discrete Fourier transform (DFT), a dynamic range of frequency resolution and frequency response can be changed freely. The ability to efficiently realize z-transform at any point M on a z-plane is also one of the characteristics of the chirp z-transform.

In general, the chirp z-transform is equivalent to DFT at point N where z=r exp(jωₙ) (equivalent to DFT on a circumference of a unit circle where the size r=1 and the normalized frequency ωₙ=2π/N). Here, the chirp z-transform can be expressed as the following equation (6).

$$\begin{matrix}[ Equation 4 ] & \\ Y ( {z}_{k} ) = {\sum }_{n = 0}^{N - 1} y ( n ) {A}^{n} {W}^{nk} , k = 0 , 1 , … , M - 1 , \\ A = r \\ M = N \\ W = exp ( - j2π / N ) & ( 6 )\end{matrix}$$

where A=A₀exp(j2πθ₀) and W=W₀exp(j2πφ₀). Here, θ₀ and φ₀ denote the initial phase. As mentioned earlier, where A=1, M=N, and W=exp(−j2π/N), CZT is equivalent to DFT.

### [Principle of Blind Detection]

In the present embodiment, the use of the above-described chirp z-transform realizes blind detection of digital watermark data that has been embedded in an acoustic signal using the first cochlear delay filter 102a and the second cochlear delay filter 102b. A description is now given of the principle of this blind detection.

The poles and zeroes of the first cochlear delay filter 102a and the second cochlear delay filter 102b are arranged as shown in FIG. 6. As mentioned earlier, these cochlear delay filters 102a and 102b are first-order IIR all-pass filters. The characteristics of the cochlear delay filters 102a and 102b are such that, when a perpendicular line is drawn from a central point toward a unit circle, the pole (“x” in FIG. 6) and zero (“∘” in FIG. 6) are the intersecting radius and the inverse thereof (bₘ and 1/bₘ), respectively. In general, as a value of bₘ decreases, a pole approaches the central point, and a zero moves away from the unit circle toward the outside. Conversely, as a value of bₘ increases, a pole and a zero both approach the unit circle. In this case, the amount of group delay increases as a value of bₘ increases, as shown in FIG. 3. Note that in FIG. 6, thick “∘” and “x” respectively represent a pole and a zero of the first cochlear delay filter 102a, whereas thin “∘” and “x” respectively represent a pole and a zero of the second cochlear delay filter 102b.

A watermarked acoustic signal y(n) is observed as a signal embedded with the above-described delay information. Therefore, blind detection can be realized by estimating the delay information from y(n), that is to say, the positions of poles and zeroes of the cochlear delay filters used to apply the delay information.

As the original signal x(n) itself has poles and zeroes as characteristics of numerical sequences (e.g., poles associated with attenuation of the signal, provided that the audio source is bounded), even if the positions of poles and zeroes can be estimated from the observed signal y(n), it is necessary to find out whether they have been applied by the IIR all-pass filters (cochlear delay filters) or are inherent in the original signal itself.

In order to demonstrate the ability to estimate the positions of poles and zeroes of the cochlear delay filters using the chirp z-transform, frequency analysis is conducted by selecting r such that it passes through the zeroes, r=1/bₘ, of the cochlear delay filters according to the aforementioned equation (1), and applying chirp z-transform (A=r, M=N, and W=exp(−j2π/N)) to the original signal x(n) and to the signal y(n) embedded with the delay information.

It will be assumed that an instrument sound serving as the original signal is x(n), and a signal that has been embedded with digital watermark data “AIS-Lab.” using the first cochlear delay filter 102a and the second cochlear delay filter 102b is y(n). Here, frequency analysis is conducted by applying chirp z-transform under the following conditions: the first cochlear delay filter 102a and the second cochlear delay filter 102b both have poles and zeroes arranged in direct-current components, and r=1/b₀ or r=1/b₁. It will be also assumed that delay information equivalent to 1 bit is embedded in one frame (250 ms) at a sampling frequency of 44.1 kHz and a bit rate N_{bit} of 4 bps.

FIGS. 7A to 7I are graphs showing the results of the analysis. Specifically, FIGS. 7A to 7I show the results of analyzing frequency spectra of x(n) in frame #1, y(n) in frame #1, and y(n) in frame #2, from left to right, with application of chirp z-transform under the conditions r=1, r=1/b₀, and r=1/b₁, from top to bottom. As shown in FIG. 7G, the result of analysis with regard to x(n) does not show any particular changes in the spectrum near the frequencies at which the pole and zero are arranged. On the other hand, it can be seen that the result of chirp z-transform for y(n) in frame #1 under the condition r=1/b₁ (FIG. 7H), as well as the result of chirp z-transform for y(n) in frame #2 under the condition r=1/b₀ (FIG. 7F), show a dramatic decrease in spectral components (indicated by arrows in FIGS. 7H and 7F) in the lowest frequency range (from direct-current components through a low frequency range; for example, a frequency band with delay shown in FIG. 3). This corresponds to a dip (sink) due to the effect of zeroes. Therefore, in principle, these spectral components have a size of −∞ dB. The results of other analyses (under the conditions r=1, r=1/b₀ (for frame #1), and r=1/b₁ (for frame #2)) show no substantial change in spectral components in the lowest frequency range (that is to say, the spectral components do not approach −∞ dB (0 in a linear form)). It has been confirmed that similar results are obtained for other frames and other target signals.

In view of the above, it is appreciated that regardless of a target signal, the positions of zeroes of the cochlear delay filters can be estimated from y(n) by applying chirp z-transform along trajectories on the z-plane intersecting the zeroes of the cochlear delay filters. In principle, chirp z-transform can be applied also by setting r to a value of a pole instead of a zero (in this case, a spectrum peak of ∞ dB is obtained). This, however, requires detection of an overflow in a dynamic range on a calculator. Therefore, it is preferable to use a zero. In the case where a zero is used, 0 in a dynamic range should be searched for, and therefore simpler processing suffices.

In the present embodiment, the first chirp z-transform unit 202a applies chirp z-transform along a trajectory on the z-plane under the condition r=1/b₀, whereas the second chirp z-transform unit 202b applies chirp z-transform along a trajectory on the z-plane under the condition r=1/b₁. By using the result of these chirp z-transforms, it is possible to estimate which one of the first cochlear delay filter 102a (filter coefficient b₀) and the second cochlear delay filter 102b (filter coefficient b₁) has introduced group delay in the target signal.

### [Operations of Digital Watermark Embedding Device 1 and Digital Watermark Detection Device 2]

The following describes the operations of the digital watermark embedding device 1 and the digital watermark detection device 2 according to the present embodiment configured in the above manner with reference to flowcharts of FIGS. 8 and 9 as well as FIGS. 2 and 5.

### [Digital Watermark Embedding Processing]

FIG. 8 is a flowchart showing a procedure of digital watermark embedding processing executed by the digital watermark embedding device 1 in an embodiment of the present invention.

The digital watermark embedding device 1 causes the frame processing unit 101 to divide an acoustic signal (original signal) input from the outside into frames (step S101). Next, the digital watermark embedding device 1 causes the filter selection unit 103 to select a cochlear delay filter to apply in accordance with a bit value of digital watermark data. More specifically, the filter selection unit 103 determines whether a bit value of digital watermark data, which has been input from the outside and converted into data in binary format, is “0” or “1” (step S102), and selects the first cochlear delay filter 102a or the second cochlear delay filter 102b in accordance with a result of the determination. Examples of digital watermark data include copyright information, such as a name of a copyright owner, and a serial number.

If the bit value of the digital watermark data is determined to be “0” in step S102 (“0” of step S102), the digital watermark embedding device 1 applies phase modulation to the acoustic signal (original signal) using the first cochlear delay filter 102a (step S103). On the other hand, if the bit value of the digital watermark data is determined to be “1” (“1” of step S102), the digital watermark embedding device 1 applies phase modulation to the acoustic signal (original signal) using the second cochlear delay filter 102b (step S104). Through these steps S103 and S104, the digital watermark data is embedded in the acoustic signal.

Then, the digital watermark embedding device 1 determines whether or not all of the bits in the digital watermark data to be embedded in a target frame have been processed (step S105). If the digital watermark embedding device 1 determines that there is any bit left that has not been processed yet (NO of step S105), it returns to step S102 and repeats processing from step S102. On the other hand, if the digital watermark embedding device 1 determines that all of the bits have been processed (YES of step S105), it generates a watermarked acoustic signal by merging acoustic signals that were embedded with the bits of the digital watermark data in steps S103 and S104 (step S106).

A watermarked acoustic signal y(n) is generated by executing the above-described digital watermark embedding processing for all frames and connecting the frames. In order to prevent a situation where the imperceptibility is affected by the occurrence of discontinuity in connection between frames (which is a cause of spectral diffusion), it is preferable to smooth a few points (approximately 1 ms) of an end portion of each frame preceding connection using spline interpolation.

### [Digital Watermark Detection Processing]

A description is now given of digital watermark detection processing for detecting digital watermark data from a watermarked acoustic signal that has been embedded with the digital watermark data in the above-described manner. As stated earlier, in the present embodiment, blind detection is performed whereby the original signal is not referred to. It will be assumed that the digital watermark detection device 2 stores information indicating a bit rate at which the digital watermark embedding device 1 embedded digital watermark data, and configures later-described settings for segments based on such information.

FIG. 9 is a flowchart showing a procedure of digital watermark detection processing executed by the digital watermark detection device 2 in an embodiment of the present invention.

The digital watermark detection device 2 causes the frame processing unit 201 to divide a watermarked acoustic signal input from the outside into frames (step S201). Next, the digital watermark detection device 2 sets a segment targeted for processing (step S202), and causes the first chirp z-transform unit 202a to apply chirp z-transform to an acoustic signal in the target segment (step S203). The digital watermark detection device 2 also causes the second chirp z-transform unit 202b to apply chirp z-transform to the same acoustic signal (step S204).

Thereafter, the digital watermark detection device 2 determines which one of the two frequency spectra obtained in steps S203 and S204 shows a drastic decrease in a spectral value in the lowest frequency, and estimates a zero of the cochlear delay filter that applied phase modulation to this acoustic signal based on a result of the determination (step S205). In the case of the present embodiment, the zero is assumed to be 1/b₀ if the frequency spectrum obtained by the first chirp z-transform unit 202a shows such a drastic decrease in the spectral value, and the zero is assumed to be 1/b₁ if the frequency spectrum obtained by the second chirp z-transform unit 202b shows such a drastic decrease in the spectral value.

Subsequently, the digital watermark detection device 2 causes the bit value detection unit 203 to determine whether the zero of the cochlear delay filter estimated in step S205 is 1/b₀ or 1/b (step S206). If the zero is determined to be 1/b₀ (1/b₀ of step S206), a bit value “0” is detected (step S207). On the other hand, if the zero is determined to be 1/b₁ (1/b₁ of step S206), a bit value “1” is detected (step S208).

Then, the digital watermark detection device 2 determines whether or not processing has been executed for all of the segments in a frame targeted for processing (step S209). If the digital watermark detection device 2 determines that there is any segment left that has not been processed yet (NO of step S209), it returns to step S202 and repeats processing from step S202. On the other hand, if the digital watermark detection device 2 determines that all of the segments have been processed (YES of step S209), it reconstructs digital watermark data by merging the bit values detected by the bit value detection unit 203 in steps S207 and S208 (step S210).

In the above manner, blind detection of digital watermark data that has been embedded in an acoustic signal using the cochlear delay filters can be realized.

[Evaluation Based on Comparison with Other Methods]

Below, the imperceptibility of digital watermark data embedded by the above-described digital watermark embedding processing according to the present embodiment, as well as the accuracy of bit detection by the above-described digital watermark detection processing according to the present embodiment, will be evaluated based on comparison with other methods.

The inventors have conducted an objective evaluation experiment using all of the 102 tracks retrieved from an RWC music database (Goto, Hashiguchi, Nishimura, and Oka, “RWC music database: music genre database and musical instrument sound database”, Information Science Study Report, 2002-MUS-45-4, 19-26, 2002) as original signals for evaluation (at a sampling frequency of 44.1 kHz, quantized to 16 bits). The experiment used the first ten seconds as the original tracks, and information of eight characters (“AIS-Lab.”) was embedded in each original signal as watermark information. Furthermore, using N_{bit}=4 bps as a base, digital watermark data was embedded in both channels of each original signal at N_{bit}s under 12 conditions (N_{bit}s=4 bps, 8 bps, 16 bps, 32 bps, 64 bps, 128 bps, 256 bps, 512 bps, 1024 bps, 2048 bps, 4096 bps, and 819 bps), and the characteristics thereof were evaluated. With regard to the evaluation of audio quality, the experiment used perceptual evaluation measurements for audio signals (PEAQ) (P. Kabal, “An examination and interpretation of ITU-R BS.1387: Perceptual evaluation of audio quality”, TSP Lab. Technical Report, Dept. Electrical & Computer Engineering, McGUniv. 2002), as well as log spectrum distortion (LSD) measurements, based on Y. Lin and W. H. Abdulla, “Perceptual evaluation of audio watermarking using objective quality measure”, Proc. ICASSP2008, 1745-1748, 2008.

The LSB, DSS, ECHO, and PPM methods, which are representative digital acoustic watermarking methods, were used as targets of comparison. Note that these methods are all blind detection methods, except for the PPM method. Furthermore, the CD method proposed by the inventors in Non-Patent Document 6 and Non-Patent Document 7 was also used as a target of comparison. Below, this CD method used as a target of comparison will be referred to as a CD (non-blind) method, whereas the digital watermark detection method according to the present embodiment will be referred to as a CD (blind) method.

FIGS. 10A to 10C are graphs showing the results of the aforementioned objective evaluation experiment. Specifically, FIGS. 10A to 10C show the results of the experiment with regard to PEAQ, LSD, and a bit detection rate, respectively. Note that FIGS. 10A to 10C show average values of the aforementioned 102 tracks.

First, the result shown in FIG. 10A will be discussed. An ODG (objective difference grade) value of PEAQ is graded as 0 (imperceptible) to −4 (extremely annoying). In view of this, −1 (perceptible but not annoying) was set as a threshold for imperceptibility in the experiment. As shown in FIG. 10A, the DSS method yielded the worst result, and the result of the ECHO method drastically worsened at a bit rate of 8 bps and higher. The PPM method overall yielded an ODG of approximately −2. On the other hand, the LSB method yielded a preferable result at all of the bit rates used in the experiment. The CD (non-blind) method did not have any drawbacks at a bit rate of 4 bps. However, the ODG value thereof started to decrease from approximately 128 bps, and fell below the threshold −1 at approximately 1024 bps and higher. In contrast, the ODG value of the CD (blind) method according to the present embodiment already neared −1.0 at 64 bps, and decreased to approximately −3.0 as bps increased.

Next, the result shown in FIG. 10B will be discussed. It is generally said that good audio quality is attained if distortion indicated by LSD is smaller than 1 dB. Therefore, 1 dB was set as a threshold for LSD in the experiment. As shown in FIG. 10B, the LSB method was not affected by distortion caused by the embedding, even if the bit rate changed, and thus yielded a preferable result. On the other hand, it can be seen that the LSD of the DSS method exceeded the evaluation threshold regardless of the increase in the bit rate; that is to say, the DSS method had a drawback in terms of the evaluation of audio quality. The LSDs of the ECHO method and the PPM method fell below the evaluation threshold. Therefore, it cannot be said that the ECHO method and the PPM method had any particular drawbacks in terms of audio quality. The CD (non-blind) method yielded a preferable result where the LSD fell below the threshold at all of the bit rates, and was maintained at 0.5 dB or lower up until 256 bps. On the other hand, the LSD of the CD (blind) method monotonically increased as the bit rate increased. Although it was at or below the threshold (−1 dB) where N_{bit}<1024 bps, it had a somewhat large value compared to the LSD of the CD (non-blind) method. However, around 4 bps to 64 bps, the LSD of the CD (blind) method had a somewhat smaller value than the LSD of the CD (non-blind) method. It should be noted that a difference between the LSD of the CD (blind) method and the LSD of the CD (non-blind) method is not as large as a difference between the PEAQ of the CD (blind) method and the PEAQ of the CD (non-blind) method shown in FIG. 10A. This is presumably because a difference between the CD (blind) method and the CD (non-blind) method is larger difference when using measurements based on the auditory impression than when using simple spectrum distortion.

Finally, the result shown in FIG. 10C will be discussed. In the experiment, 75% was set as a threshold for the bit detection rate. As shown in FIG. 10C, all of the methods showed a decrease in the bit detection rate as the bit rate increased, except for the LSB method. While the bit detection rate of the CD (non-blind) method fell below the threshold at N_{bit} of approximately 1024 bps, the bit detection rates of other conventional methods fell below the threshold at much lower bit rates. On the other hand, the CD (blind) method according to the present embodiment did not show a substantial decrease in the bit detection rate, and yielded a preferable result compared to the CD (non-blind) method. More specifically, the bit detection rate of the CD (blind) method was almost 100% where N_{bit}<512, and marked 98% at 1024 bps.

The LSB method yielded the best result in the above-described objective evaluation experiment. However, as pointed out in, for example, Non-Patent Document 6 and Non-Patent Document 7, the LSB method has a significant drawback in terms of robustness as it cannot detect an embedded signal if the embedded signal is modified, even to a small extent. In contrast, the CD (non-blind) method offers sufficient robustness as indicated by, for example, Unoki, M., Imabeppu, K., Hamada, D., Haniu, A., and Miyauchi, R. “Embedding limitations with digital-audio watermarking method based on cochlear delay characteristics”, J. Information Hiding and Multimedia Signal Processing, 2(1), 1-23, 2011. Nevertheless, a problem with the CD (non-blind) method is that it cannot perform blind detection. The CD (blind) method according to the present embodiment can solve this problem and also offer excellent imperceptibility and robustness.

### [Original Signal Acquisition Processing]

Many of the conventional digital acoustic watermarking techniques only take into consideration the detection of digital watermark data embedded in an original signal, but do not discuss removal of the digital watermark data after the detection. Therefore, there has been no innovation for removing embedded digital watermark data. That is to say, digital watermark data is embedded in a manner that requires difficulty in removing the same. For this reason, it can be said that many of the conventional techniques are irreversible digital acoustic watermarking techniques. In contrast, in the present embodiment, digital watermark data is embedded through relatively uncomplicated processing in which phase modulation is applied to an original signal using the cochlear delay filters. In this way, after the digital watermark data is embedded, the original signal can be acquired by removing the detected digital watermark data in a simple method using the detected digital watermark data. The present embodiment can thus realize a reversible digital acoustic watermarking technique. The following describes such processing for acquiring the original signal.

FIG. 11 is a flowchart showing a procedure of original signal acquisition processing executed by the digital watermark detection device 2 in an embodiment of the present invention. It will be assumed that the digital watermark detection device 2 includes inverse filters for the first cochlear delay filter 102a and the second cochlear delay filter 102b included in the digital watermark embedding device 1, that is to say, filters that have characteristics that are the inverse of the cochlear delay characteristics simulated by the first cochlear delay filter 102a and the second cochlear delay filter 102b.

The digital watermark detection device 2 causes the frame processing unit 201 to divide a watermarked acoustic signal input from the outside into frames (step S301). Next, the digital watermark detection device 2 refers to digital watermark data detected by the aforementioned digital watermark detection processing (step S302), and determines whether a bit value of the digital watermark data is “0” or “1” (step S303).

If the bit value of the digital watermark data is determined to be “0” in step S303 (“0” of step S303), the digital watermark detection device 2 applies phase modulation to the watermarked acoustic signal using the inverse filter for the first cochlear delay filter 102a (step S304). On the other hand, if the bit value of the digital watermark data is determined to be “1” in step S303 (“1” of step S303), the digital watermark detection device 2 applies phase modulation to the watermarked acoustic signal using the inverse filter for the second cochlear delay filter 102b (step S305).

Then, the digital watermark embedding device 1 determines whether or not all of the bits in the digital watermark data embedded in a target frame have been processed (step S306). If the digital watermark detection device 2 determines that there is any bit left that has not been processed yet (NO of step S306), it returns to step S303 and repeats processing from step S303. On the other hand, if the digital watermark detection device 2 determines that all of the bits have been processed (YES of step S306), it reconstructs the original signal by merging acoustic signals to which phase modulation was applied in steps S304 and S305 (step S307).

The original signal is acquired by executing the aforementioned original signal acquisition processing for all frames and connecting the frames. Similarly to the case of the digital watermark embedding processing, in order to prevent a situation where the imperceptibility is affected by the occurrence of discontinuity in connection between frames, it is preferable to smooth a few points (approximately 1 ms) of an end portion of each frame preceding connection using spline interpolation.

### [Evaluation of Original Signal Acquisition Processing]

An experiment similar to the above-described objective evaluation experiment was conducted to confirm whether or not a signal acquired through the above-described original signal acquisition processing matches the actual original signal. The result of this experiment will now be discussed.

FIGS. 12A to 12C are graphs showing the results of the aforementioned objective evaluation experiment for a watermarked acoustic signal generated through digital watermark embedding processing using the CD (non-blind) method and the CD (blind) method. Specifically, FIGS. 12A to 12C show the results of the experiment with regard to PEAQ, LSD, and a bit detection rate, respectively. Note that FIGS. 12A to 12C show average values of the aforementioned 102 tracks.

In FIGS. 12A to 12C, the result of the CD (blind) method is presented separately for the case where the aforementioned spline interpolation was executed (blind (with spline)) and for the case where the aforementioned spline interpolation was not executed (blind (without spline)). It can be seen from FIGS. 12A to 12C that better results were yielded with regard to all of PEAQ, LSD, and the bit detection rate when the spline interpolation was executed than when the spline interpolation was not executed. It should be noted, however, that there is little difference between the bit detection rate obtained when the spline interpolation was executed and the bit detection rate obtained when the spline interpolation was not executed.

On the other hand, FIGS. 13A to 13C are graphs showing the results of the aforementioned objective evaluation experiment obtained before and after the digital watermark data was deleted through the original signal acquisition processing according to the present embodiment. Specifically, FIGS. 13A to 13C show the results of the experiment with regard to PEAQ, LSD, and SNR (signal-to-noise ratio), respectively. Note that S and N of this SNR refer to the original signal and a difference between the original signal and a recovered signal (a signal acquired through the aforementioned original signal acquisition processing), respectively. Note that FIGS. 13A to 13C also show average values of the aforementioned 102 tracks.

It can be seen from FIGS. 13A to 13C that better results were yielded overall after the digital watermark data was deleted than before the digital watermark data was deleted. This is notable especially with the SNR shown in FIG. 13C. The closer the recovered signal is to the original sound, the higher the value of the SNR is. Therefore, it can be said that the result shown in FIG. 13C indicates that the signal acquired through the original signal acquisition processing according to the present embodiment is close to the original signal, that is to say, the embedded digital watermark data was able to be effectively deleted from the watermarked acoustic signal.

As described above, in the present embodiment, an original signal can be acquired by removing digital watermark data from a watermarked acoustic signal through simple processing of applying phase modulation using inverse filters for the cochlear delay filters. As the original signal can be acquired in this way, it is possible to embed new digital watermark data in the acquired original signal and distribute the original signal. This makes it possible to realize a digital acoustic watermarking technique that can update the contents of embedded information (for example, copyright information and a serial number).

### Second Embodiment

A second embodiment is a tampering detection device that can detect tampering with an acoustic signal using a watermark detection method described in the first embodiment.

With recent progress in digital technology, various types of acoustic signals, such as speech and music, are being handled as digital data. It is expected that this trend will further accelerate in the future, and acoustic signals of digital data will be used in diverse fields. As digital data can be processed easily compared to analog data, various processing/editing techniques already exist in large numbers, and various techniques targeted for acoustic signals have been proposed as well. For example, JP 2003-108177A proposes a speech synthesis system for phonemic pieces with which natural pronunciation can be achieved when synthesizing pitch-converted phonemic piece data into speech. On the other hand, JP 3251555B proposes a speech synthesis system of a so-called vocoder type. By using these speech synthesis techniques and the like, acoustic signals can easily be processed and edited. This may lead to, for example, a situation in which acoustic signals are tampered with in a fashion unintended by the original owner. However, as it is difficult to detect such tampering with acoustic signals at present, there is a possibility that data of fraudulent copies that have been tampered with will be spread.

After studying various methods for detecting tampering with acoustic signals, the inventors focused their attention on MIH (multimedia information hiding) techniques and found a method for determining whether or not the acoustic signals have been tampered with based on digital watermark data embedded in the acoustic signals. The inventors also considered such use of digital watermark data applicable in diverse fields as it enables detection of tampering as a measure against illegal copies. The following describes the configuration and operations of the tampering detection device according to the present embodiment.

### [Configuration of Tampering Detection System]

FIG. 14 is an explanatory drawing showing an outline of the tampering detection system according to the second embodiment of the present invention. As shown in FIG. 14, the tampering detection system according to the present embodiment includes the digital watermark embedding device 1 described in the first embodiment and a tampering detection device 3 that detects tampering with an acoustic signal. The owner of the acoustic signal inputs the acoustic signal to the digital watermark embedding device 1. Upon receiving the acoustic signal as input, the digital watermark embedding device 1 embeds digital watermark data in the acoustic signal. A watermarked acoustic signal thus generated is distributed to users via communication networks, such as the Internet, and other means.

If any of the users tampers with the watermarked acoustic signal by rewriting a part of the watermarked acoustic signal or applying other processing to the watermarked acoustic signal, that person may fraudulently distribute the acoustic signal that he/she has tampered with. When the tampering detection device 3 acquires the tampered acoustic signal that has been fraudulently distributed, it detects tampering with the acoustic signal using the digital watermark data that was embedded in the acoustic signal by the digital watermark embedding device 1.

In this way, the tampering detection system according to the present embodiment realizes tampering detection through coordination between the digital watermark embedding device 1 and the tampering detection device 3. A description is now given of a specific configuration of the tampering detection device 3.

### [Configuration of Tampering Detection Device]

FIG. 15 is a block diagram showing the configuration of the tampering detection device according to the first embodiment of the present invention. As shown in FIG. 15, the tampering detection device 3 includes a CPU 31, a ROM 32, a RAM 33, a signal input unit 34, a hard disk drive 35, a display unit 36, and an acoustic output unit 37. These CPU 31, ROM 32, RAM 33, signal input unit 34, hard disk drive 35, display unit 36, and acoustic output unit 37 are connected by a bus 38.

The CPU 31, the ROM 32 and the RAM 33 are similar to the CPU 11, the ROM 12 and the RAM 13 included in the digital watermark embedding device 1, respectively, and therefore a description thereof is omitted.

The signal input unit 34 receives, as input, an acoustic signal targeted for tampering detection from an external device. This acoustic signal contains the watermarked acoustic signal generated by the digital watermark embedding device 1, as well as a tampered acoustic signal generated by tampering with that watermarked acoustic signal.

An operating system, various computer programs to be executed by the CPU 31, and the like are installed in the hard disk drive 35, similarly to the case of the digital watermark embedding device 1. These computer programs include a tampering detection program 35A for detecting embedded data that has been embedded in the acoustic signal targeted for tampering detection and determining whether or not tampering has been applied based on the detected embedded data.

The tampering detection program 35A installed in the hard disk drive 35 may be provided from a portable recording medium or via an electric communication line, similarly to the case of the digital watermark embedding program 16A. It will be assumed that this tampering detection program 35A runs on the operating system installed in the hard disk drive 35, similarly to the case of the digital watermark embedding program 16A.

The display unit 36 is constituted by a liquid crystal display and the like, and displays an image (screen) in accordance with an instruction from the CPU 31. The acoustic output unit 37 is constituted by a speaker and the like, and outputs an acoustic signal in accordance with an instruction from the CPU 31.

Below, the aforementioned configuration of the tampering detection device 3 will be described with reference to functional block diagrams of FIGS. 16 and 17.

FIG. 16 is a functional block diagram showing a configuration of the CPU 31. As shown in FIG. 16, the CPU 31 includes an embedded data detection unit 301, a digital watermark data generation unit 302, a data comparison unit 303, and a tampering detection unit 304. The embedded data detection unit 301 detects embedded data that has been embedded in the acoustic signal supplied from the outside via the signal input unit 34. A specific configuration of this embedded data detection unit 301 will be described later with reference to FIG. 17.

The digital watermark data generation unit 302 generates image data (digital watermark data), which is data of a bit string, using owner information supplied from the outside via the signal input unit 34. Note that this owner information is the same as the one supplied to a digital watermark data generation unit 101 in the digital watermark embedding device 1. Therefore, the digital watermark embedding device 1 and the tampering detection device 3 generate the same digital watermark data.

The data comparison unit 303 compares the embedded data detected by the embedded data detection unit 301 with the digital watermark data generated by the digital watermark data generation unit 302. The tampering detection unit 304 determines whether or not the acoustic signal targeted for tampering detection has been tampered with based on the result of the comparison by the data comparison unit 303.

Specifics of the embedded data embedding unit 301 will now be described. FIG. 17 is a functional block diagram showing a configuration of the embedded data detection unit 301. As shown in FIG. 17, the embedded data detection unit 301 includes a frame processing unit 301a, two chirp z-transform units 301b and 301c, and a bit value detection unit 301d. The frame processing unit 301a divides an acoustic signal y(n) targeted for tampering detection, which has been acquired from the outside, into frames (configured in a manner similar to the frame processing unit 201 according to the first embodiment). The chirp z-transform units 301b and 301c apply chirp z-transform to the acoustic signal y(n) divided into frames (configured in a manner similar to the chirp z-transform units 202a and 202b according to the first embodiment). The bit value detection unit 301d detects a bit value of the embedded data based on the result of chirp z-transform applied by the first chirp z-transform unit 301b and the second chirp z-transform unit 301c (configured in a manner similar to the bit value detection unit 203 according to the first embodiment).

In the present embodiment, these embedded data detection unit 301 (frame processing unit 301a, first chirp z-transform unit 301b, second chirp z-transform unit 301c, and bit value detection unit 301d), digital watermark data generation unit 302, data comparison unit 303, and tampering detection unit 304 are realized by the CPU 31 executing the tampering detection program 35A.

### [Operations of Digital Watermark Embedding Device 1 and Tampering Detection Device 3]

The following describes the operations of the digital watermark embedding device 1 and the tampering detection device 3 configured in the above-described manner with reference to flowcharts.

### [Digital Watermark Embedding Processing]

The digital watermark embedding device 1 generates a watermarked acoustic signal by executing processing similar to the digital watermark embedding processing according to the first embodiment, which has been described earlier with reference to the flowchart of FIG. 8.

The watermarked acoustic signal thus generated is converted into an appropriate format by a coding processing unit 303 and then output to the outside for distribution to the users in the above-described manner.

### [Tampering Detection Processing]

After a watermarked acoustic signal embedded with digital watermark data has been distributed to the users in the above-described manner, tampering detection processing is executed in which the tampering detection device 3 determines whether or not the acoustic signal acquired from the outside has been tampered with. The following describes two types of processing composing the tampering detection processing, i.e., (a) embedded data detection processing (blind detection), and (b) tampering determination processing. Note that there are various conceivable ways to acquire the acoustic signal. For example, the acoustic signal may be acquired via communication networks, such as the Internet, and from a portable recording medium, such as a CD-ROM.

As stated earlier, in the present embodiment, blind detection is performed whereby the original signal is not referred to. It will be assumed that the tampering detection device 3 stores information indicating a bit rate at which the digital watermark embedding device 1 embedded digital watermark data, and configures later-described settings for segments based on such information.

(a) Digital Watermark Detection Processing (Blind Detection)

FIG. 18 is a flowchart showing a procedure of the embedded data detection processing executed by the tampering detection device 3.

The tampering detection device 3 causes the frame processing unit 301a to divide an acoustic signal target for tampering detection, which has been acquired from the outside, into frames (step S401). Next, the tampering detection device 3 sets a segment targeted for processing (step S402), and causes the first chirp z-transform unit 301b to apply chirp z-transform to an acoustic signal in the target segment (step S403). The tampering detection device 3 also causes the second chirp z-transform unit 301c to apply chirp z-transform to the same acoustic signal (step S404).

Thereafter, the tampering detection device 3 determines which one of the two frequency spectra obtained in steps S403 and S404 shows a drastic decrease in a spectral value in the lowest frequency, and estimates a zero of the cochlear delay filter that applied phase modulation to this acoustic signal based on a result of the determination (step S405). In the case of the present embodiment, the zero is assumed to be 1/b₀ if the frequency spectrum obtained by the first chirp z-transform unit 301b shows such a drastic decrease in the spectral value, and the zero is assumed to be 1/b₁ if the frequency spectrum obtained by the second chirp z-transform unit 301c shows such a drastic decrease in the spectral value.

Subsequently, the tampering detection device 3 causes the bit value detection unit 301d to determine whether the zero of the cochlear delay filter estimated in step S405 is 1/b₀ or 1/b (step S406). If the zero is determined to be 1/b₀ (“1/b₀” of step S406), a bit value “0” is detected (step S407). On the other hand, if the zero is determined to be 1/b₁ (“1/b₁” of step S406), a bit value “1” is detected (step S408).

Then, the tampering detection device 3 determines whether or not processing has been executed for all of the segments in a frame targeted for processing (step S409). If the tampering detection device 3 determines that there is any segment left that has not been processed yet (NO of step S409), it returns to step S402 and repeats processing from step S402. On the other hand, if the tampering detection device 3 determines that all of the segments have been processed (YES of step S409), it reconstructs embedded data by merging the bit values detected by the bit value detection unit 303 in steps S407 and S408 (step S410).

In the above manner, blind detection of embedded data that has been embedded in an acoustic signal using the cochlear delay filters can be realized.

(b) Tampering Determination Processing

FIG. 19 is a flowchart showing a procedure of the tampering determination processing executed by the tampering detection device 3.

The tampering detection device 3 causes the data comparison unit 303 to compare the digital watermark data (bit string) generated by the digital watermark data generation unit 302 with the embedded data (bit string) detected and reconstructed by the embedded data detection unit 301 in the above-described manner on a per-bit basis (step S501). If the result of comparison shows that bit values of all bits match between the digital watermark data and the embedded data (YES of step S502), the tampering detection device 3 displays, on the display unit 36, a tampering non-detection message indicating that tampering with the acoustic signal targeted for tampering detection has not been detected (step S503). On the other hand, if the result of comparison shows that at least one of the bit values does not match between the digital watermark data and the embedded data (NO of step S502), the tampering detection device 3 identifies the mismatched bit (step S504) and displays, on the display unit 36, a tampering detection message indicating that the mismatched bit has been tampered with (step S505).

In this way, the present embodiment makes it possible to determine whether or not an acoustic signal has been tampered with, and if the acoustic signal has been tampered with, which of the bits in the acoustic signal has been tampered with.

When the tampering detection device 3 displays a tampering detection message either in accordance with a user's instruction or in the aforementioned step S505, it may cause the acoustic output unit 37 to output either the entirety of an acoustic signal for which tampering has been detected or a part of the acoustic signal including one or more bits that have been tampered with. In this case, it is preferable that, when outputting the part including one or more bits that have been tampered with, the display unit 36 displays the fact that this part has been tampered with. Consequently, users can easily confirm which part has been tampered with.

In the case where cochlear delay filters are used as in the present embodiment, digital watermark data is resistant to destruction when signal transformation (audio coding) is applied to an acoustic signal, but is easily destructed when the acoustic signal is tampered with. Therefore, the present embodiment enables accurate determination as to whether or not tampering has been applied by measuring a degree of destruction of digital watermark data.

### Third Embodiment

As described above, the tampering detection device according to the second embodiment makes use of blind detection. In contrast, a tampering detection device according to a third embodiment makes use of non-blind detection (digital watermark data is detected with reference to an original signal). The following describes the configuration and operations of the tampering detection device according to the present embodiment. It should be noted that hardware configurations of a digital watermark embedding device and a tampering detection device are similar to those of the aforementioned digital watermark embedding device 1 and tampering detection device 3, and therefore a description thereof is omitted.

### [Configurations of Digital Watermark Embedding Device and Tampering Detection Device]

FIG. 20 is a functional block diagram showing the configurations of a digital watermark embedding device and a tampering detection device according to the third embodiment. As shown in FIG. 20, a digital watermark embedding device 4 includes a coding unit 401, a first cochlear delay filter 402a, a second cochlear delay filter 402b, and a selective weighted sum merging unit 403. The coding unit 401 converts digital watermark data into data of predetermined expression. The selective weighted sum merging unit 403 executes selective weighted sum processing, which will be described later. In the present embodiment, these coding unit 401, first cochlear delay filter 402a, second cochlear delay filter 402b, and selective weighted sum merging unit 403 are realized by a CPU of the digital watermark embedding device 4 executing a digital watermark embedding program for digital watermark embedding processing, which will be described later. As the first cochlear delay filter 402a and the second cochlear delay filter 402b are similar to the first cochlear delay filter 102a and the second cochlear delay filter 102b according to the first embodiment, a description thereof is omitted.

Meanwhile, as shown in FIG. 20, a tampering detection device 5 includes phase calculation units 501a and 501b, a phase difference detection unit 502, and a decoding unit 503. The phase calculation units 501a and 501b calculate phase spectra of an acoustic signal targeted for tampering detection and an acoustic signal (original signal), respectively. The phase difference detection unit 502 detects a phase difference between the two acoustic signals. The decoding unit 503 reconstructs embedded data. In the present embodiment, these phase calculation units 501a and 501b, phase difference detection unit 502, and decoding unit 503 are realized by a CPU of the tampering detection device 5 executing a tampering detection program for tampering detection processing, which will be described later.

### [Operations of Digital Watermark Embedding Device and Tampering Detection Device]

A description is now given of the operations of the digital watermark embedding device 4 and the tampering detection device 5 according to the present embodiment configured in the above-described manner.

### [Digital Watermark Embedding Processing]

FIG. 21 is a flowchart showing a procedure of digital watermark embedding processing executed by the digital watermark embedding device 3 in the second embodiment.

The digital watermark embedding device 4 causes the coding unit 401 to convert digital watermark data to be embedded in an acoustic signal into data in binary format (step S601). Similarly to the case of the first embodiment, this digital watermark data is image data of a bitmap format.

The digital watermark data thus converted into data in binary format is output to the selective weighted sum merging unit 403.

Next, the digital watermark embedding device 4 applies phase modulation to the acoustic signal (original signal) input from the outside using the first cochlear delay filter 402a and the second cochlear delay filter 402b (step S602). This results in generation of two acoustic signals in which cochlear delay has been artificially introduced.

The two acoustic signals that have been phase-modulated using the first cochlear delay filter 402a and the second cochlear delay filter 402b in the above-described manner are output to the selective weighted sum merging unit 403.

Thereafter, the digital watermark embedding device 4 embeds the digital watermark data in the phase-modulated acoustic signals by causing the selective weighted sum merging unit 403 to execute the following selective weighted sum processing (step S603).

In the selective weighted sum processing, the acoustic signal output from the first cochlear delay filter 402a is selected if the bit of the digital watermark data is 0, and the acoustic signal output from the second cochlear delay filter 402b is selected if the bit of the digital watermark data is 1. By merging these selected acoustic signals, the watermarked acoustic signal embedded with the digital watermark data is generated.

Here, the acoustic signals are merged through weighted summation of the acoustic signals so as to prevent a sudden phase change in merged portions. This weighted sum processing is executed by, for example, applying weights of ramped-cos. By executing such weighted sum processing, distortion of the watermarked acoustic signal is alleviated.

The aforementioned digital watermark embedding processing is expressed by equations as follows. The following description will be given with reference to a conceptual diagram shown in FIG. 22. In the following description, n denotes a sample index, and k denotes a frame index of an acoustic signal.

First, in step S601, the digital watermark data is converted into data s(k) in binary format.

Next, provided that the acoustic signal serving as the original signal is x(n), and the first cochlear delay filter 402a and the second cochlear delay filter 402b are H₀(z) and H₁(z), respectively, two phase-modulated acoustic signals (w₀(n), w₁(n)) are generated using the aforementioned equations (3) and (4) in the aforementioned step S602.

Then, in step S603, w₀(n) or w₁(n) is selected in accordance with whether the bit of the digital watermark data s(k) is 0 or 1, and the watermarked acoustic signal y(n) is generated in accordance with the aforementioned equation (5).

### [Tampering Detection Processing]

In the present embodiment also, the tampering detection processing includes embedded data detection processing and tampering determination processing, similarly to the case of the second embodiment. Among these, the tampering determination processing is similar to that of the second embodiment, and therefore a description thereof is omitted. Below, the embedded data detection processing (non-blind detection) will be described.

As stated earlier, in the digital watermark embedding processing according to the present embodiment, the watermarked acoustic signal is generated by switching between the two acoustic signals to which phase modulation has been applied using the two cochlear delay filters at a certain time interval. These two acoustic signals are obtained by applying phase modulation to the original signal. Therefore, by using a difference between phase characteristics of the original signal and the watermarked acoustic signal, it is possible to identify which one of the aforementioned two cochlear delay filters has been used to apply phase modulation to generate the watermarked acoustic signal. The embedded data detection processing (non-blind detection) takes advantage of such nature in detecting embedded data that has been embedded in the acoustic signal targeted for tampering detection.

FIG. 23 is a flowchart showing a procedure of the embedded data detection processing (non-blind detection).

The tampering detection device 5 causes the phase calculation units 501a and 501b to calculate phase spectra of an acoustic signal (original signal) and an acoustic signal targeted for tampering detection, respectively, using FFT (fast Fourier transform) (step S701). Here, the phase spectra of the acoustic signals are calculated for each bit used in the digital watermark embedding processing.

The phase spectra of the acoustic signals thus calculated are output to the phase difference detection unit 502.

Next, the tampering detection device 5 causes the phase difference detection unit 502 to calculate differences between the phase spectra of the two acoustic signals (step S702), and calculates a sum total of differences between: the calculated differences between the phase spectra; and group delay introduced by the first cochlear delay filter 402a (first sum total), as well as a sum total of differences between: the calculated differences between the phase spectra; and group delay introduced by the second cochlear delay filter 402b (second sum total) (step S703). Then, the phase difference detection unit 502 compares the first sum total and the second sum total. If the first sum total is smaller than the second sum total, “0” is detected as a bit value of the digital watermark data, and if the first sum total is equal to or greater than the second sum total, “1” is detected as a bit value of the digital watermark data (step S704). Note that this processing is equivalent to estimation of which one of the first cochlear delay filter 402a and the second cochlear delay filter 402b has been used to apply phase modulation.

After the values of all bits in the digital watermark data have been detected in the above manner, these detected bit values are output to the decoding unit 503.

Then, the tampering detection device 5 causes the decoding unit 503 to reconstruct the embedded data embedded in the acoustic signal targeted for tampering detection using the bit values detected in the above-described manner (step S705).

In the above manner, embedded data that has been embedded in an acoustic signal can be detected using the cochlear delay filters.

The aforementioned embedded data detection processing is expressed by equations as follows. The following description will be given with reference to a conceptual diagram shown in FIG. 24. In the following description, n denotes a sample index, and k denotes a frame index of an acoustic signal.

First, in step S701, phase spectra of an acoustic signal x(n) and an acoustic signal y(n) targeted for tampering detection are calculated using FFT. In step S702, differences Φ(ω) between the phase spectra of the two acoustic signals are calculated using the following equation (7).

Φ(ω)=arg(FFT[y(n)])−arg(FFT[x(n)]) (7)

Next, in step S703, a sum total ΔΦ₀ of differences between: the differences between the phase spectra of the two acoustic signals; and the first cochlear delay filter 402a (H₀(z)), as well as a sum total ΔΦ₁ of differences between: the differences between the phase spectra of the two acoustic signals; and the second cochlear delay filter 402b(H₁(z)), are calculated using the following equations (8) and (9). Here, z=e^{jω}.

Δφ₀=Σ|φ(ω)−arg(H₀(e^{jω}))| (8)

Δφ₁=Σ|φ(ω)−arg(H₁(e^{jω}))| (9)

Then, in step S704, based on a magnitude relationship between the aforementioned sum totals ΔΦ₀ and ΔΦ₁, a bit value s(k) of the embedded data is detected in accordance with the following equation (10).

s(k)=0, or Δφ₀<Δφ₁ or 1, Δφ₀≧Δφ₁ (10)

Finally, in step S705, the embedded data is reconstructed using these detected bit values s(k).

As described above, by executing the embedded data detection processing (non-blind detection), embedded data can be detected from an acoustic signal targeted for tampering detection. Thereafter, similarly to the case of the second embodiment, execution of the tampering determination processing enables determination of whether or not the acoustic signal has been tampered with, and if the acoustic signal has been tampered with, which part has been tampered with.

(Evaluation Based on Comparison with Other Methods)

The following describes comparative evaluation of tampering detection according to the second and third embodiments described above and the LSB method. Hereinafter, the blind detection method according to the second embodiment is referred to as a CD (blind) method, whereas the non-blind detection method according to the third embodiment is referred to as a CD (non-blind) method.

The inventors embedded digital watermark data (a bitmap image) in acoustic signals containing 8-second data of long-form sentences retrieved from an ATR speech database (12 sentences spoken by speakers of mixed genders, a sampling frequency of 16 kHz), and investigated evaluation criteria (PESQ (perceptual evaluation of speech quality) and LSD (log spectrum distortion)) used as requirements of the MIH technology (imperceptibility and robustness) as well as a bit detection rate of the digital watermark data. The inventors also investigated a bit detection rate after applying signal transformation (three types of audio coding, i.e., PCM (G.711), ADPCM (G.726) and CS-ACELP (G.729)) to the acoustic signals as robustness evaluation. The following describes the results of these experiments.

FIGS. 25A to 25C are graphs showing the results of the aforementioned objective evaluation experiment. Specifically, FIGS. 25A to 25C show the results of the experiment yielded using the CD (non-blind) method, the CD (blind) method and the LSB method with regard to PESQ, LSD and a bit detection rate, respectively. Note that FIGS. 25A to 25C show average values of the aforementioned 12 sentences. In the experiment, an ODG value of 3 (corresponding to PEAQ of −1 for music signal evaluation) and 1 dB were used as evaluation thresholds for PESQ and LSD, respectively. It can be confirmed from FIGS. 25A and 25B that the LSB yielded excellent PESQ and LSD. On the other hand, the results yielded by the CD (non-blind) method and the CD (blind) method were not as preferable as the result yielded by the LSB method, but were satisfactory in terms of the evaluation thresholds. Therefore, it can be said that the CD (non-blind) method and the CD (blind) method satisfy the requirements of the MIH technology. Furthermore, as shown in FIG. 25C, all of the methods sufficiently yielded a bit detection rate higher than the evaluation threshold, i.e., 75%. That is to say, with regard to the bit detection rate, all of the methods yielded preferable results. It should be noted that, compared to the CD (non-blind) method, the CD (blind) method yielded inferior results with regard to PESQ and LSD, but yielded better results with regard to the bit detection rate.

FIGS. 26A to 26C are graphs showing the results of the aforementioned robustness evaluation experiment. Specifically, FIGS. 26A to 26C show the results yielded using the CD (non-blind) method, the CD (blind) method and the LSB method, respectively. In the experiment, a bit detection rate of 75% was used as an evaluation threshold. Referring to FIGS. 26A to 26C, the CD (non-blind) method and the CD (blind) method yielded preferable results compared to the LSB method. It should be noted that a detection rate of 50% is equivalent to a chance level. That is to say, as a target bit is 0 or 1, the rate at which the correct bit is assigned by random selection is 50%. Therefore, statistically, the bit detection rate is in the vicinity of 50% at the lowest. As can be seen from FIG. 25C, the LSB method is excellent in terms of imperceptibility, but is extremely sensitive to subtle waveform processing, such as signal transformation, and is therefore vulnerable to audio coding processing that cannot be interpreted as information tampering. On the other hand, it can be appreciated from FIGS. 26A and 26B that the CD (non-blind) method and the CD (blind) method are robust against audio coding according to G.711 and G.726, but cannot sufficiently deal with G.729. However, these results are attributed to the fact that audio coding according to G.729 is not based on waveform processing. With recent dissemination of broadband with wide-band characteristics, audio coding is shifting to waveform-based coding that generates high-quality audio. Therefore, it can be said that the CD (non-blind) method and CD (blind) method are sufficiently practical even though they cannot deal with G.729.

In view of the above, by using the CD (non-blind) method and the CD (blind) method, tampering can be detected while sufficiently satisfying the requirements of the MIH technology.

The following describes examples of the types of tampering that can be dealt with in the second and third embodiments. Examples of types of tampering include a pattern in which at least a part of audio contents is replaced with other audio contents (hereinafter referred to as “information-replaced tampering”), and a pattern in which other audio contents are added to at least a part of audio contents (hereinafter referred to as “information-added tampering”). Information-replaced tampering is applied using, for example, a speech synthesis technique for phonemic pieces or a speech synthesis technique of a vocoder type. On the other hand, information-added tampering is applied, for example, through processing for making the contents of speech difficult to listen to for a listener. More specifically, processing for lowering the clarity of speech, such as addition of noise with a low SNR (high-level noise) or addition of reverberation, is conceivable.

In accordance with the second embodiment, the inventors embedded a bitmap image (acoustic watermark data) shown in FIG. 27 in 8-second data of long-form sentences retrieved from the ATR audio database (5 sentences spoken by speakers of mixed genders, a sampling frequency of 16 kHz), and investigated a bit detection rate and the detected bitmap image. Note that this image is obtained by shifting scan lines, which extend in a downward vertical direction, in a rightward horizontal direction as indicated by arrows in FIG. 27. This image has a size of 32×32 bits.

When acoustic signals were not tampered with, the bit detection rate was 100%, and bitmap images shown in FIGS. 28A to 28E were detected. Note that FIGS. 28A to 28E show the results yielded with regard to five different spoken sentences (acoustic signals). The same goes for the subsequent figures. As shown in these FIGS. 28A to 28E, the original image was mostly preserved. On the other hand, it has been found that, when audio coding according to PCM (G.711) is applied to the acoustic signals, the bit detection rate is reduced to 85%, but the detected bitmap images are extremely close to the original image, as shown in FIGS. 29A to 29E.

The following describes the results of applying the information-added tampering to the acoustic signals. First, white noise with a low SNR was applied to the acoustic signals for the purpose of interfering with listening of the contents of speech under the effect of masking. In this case, the bit detection rate was 79%, and bitmap images shown in FIGS. 30A to 30E were detected. In contrast, reverberation was added to the acoustic signals for the purpose of interfering with listening of the contents of speech under the effect of reverberation. When artificial reverberation (0.3 seconds) was added, the bit detection rate was 74%, and bitmap images shown in FIGS. 31A to 31E were detected. On the other hand, when noise from a real environment (approximately 1.0 second) was added, the bit detection rate was 74%, and bitmap images shown in FIGS. 32A to 32E were detected. As described above, when the information-added tampering was applied, all of the results showed a bit detection rate of approximately 75%, which is higher than the evaluation threshold for robustness. However, as shown in FIGS. 30A to 32E, the detected bitmap images were far from the original form.

Finally, the following describes the results of applying the information-replaced tampering to the acoustic signals. First, modification was applied for the purpose of tampering with the contents of speech while leaving information of a speaker. When modification was applied using a wavelet-type speech analysis/synthesis system (GTFB: gammatone filter bank) out of speech analysis/syntheses systems of a vocoder type, the bit detection rate was 90%, and bitmap images shown in FIGS. 33A to 33E were detected. Similarly, when modification was applied using a speech analysis/synthesis system that takes advantage of an STFT (short-time Fourier transform) pair, the bit detection rate was 91%, and bitmap images shown in FIGS. 34A to 34E were detected. In the experiment, only a speech section from 2.5 seconds to 5 seconds was replaced with a speech processed by the aforementioned analysis/synthesis systems. Furthermore, when the contents of the acoustic signals were modified through phonemic piece synthesis for the purpose of tampering with the contents of speech while leaving information of a speaker, the bit detection rate was 91%, and bitmap images shown in FIGS. 35A to 35E were detected. As described above, when the information-replaced tampering was applied, all of the results showed a high bit detection rate of approximately 90%. Furthermore, as shown in FIGS. 33A to 35E, the detected bitmap images commonly exhibited the following characteristics: they were destructed in the central portion but were close to the original image in the left and right portions.

In this way, the detected bitmap images are not destructed through audio coding, but are destructed to a certain extent if tampering has been applied. Furthermore, the degree of destruction differs between the information-replaced tampering and the information-added tampering. Therefore, if the tampering detection device detects this degree of destruction, it is possible to determine whether or not the acoustic signals have been tampered with, and if the acoustic signals have been tampered with, what type of tampering has been applied.

The aforementioned determination regarding the types of tampering can also be made in the following manner. In the case of the information-replaced tampering, delay information that has been embedded in an acoustic signal using the cochlear delay characteristics disappears, leading to a situation where it is impossible to determine whether a bit value is “0” or “1” in both of the second and third embodiments. In this case, in the second and third embodiments, “0” is always detected because a compulsory determination is made with an if sentence. For example, in the case of the first embodiment, if phonemic pieces are synthesized in a section from 2.5 seconds to 5 seconds as shown in FIG. 36A, a drop in a low-frequency spectrum that accompanies determination of a zero is not confirmed, and the spectrum has substantially the same magnitude both when a bit value is “0” and when a bit value is “1”. Therefore, as shown in FIG. 36B, a difference between the two is approximately 0 dB, and a bit value “0” is detected as a result of the aforementioned compulsory determination. The same goes for the case of the second embodiment. Thus, if a large number of sequences of bit “0” are observed in a tampered region that has been identified from the acoustic signal as shown in FIG. 36C, it is considered that the information-replaced tampering has been applied. In contrast, if bit sequences in the identified tampered region are random, it is considered that the information-added tampering has been applied.

Note that the reason why the central portions of the images are destructed in FIGS. 33A to 35E is because a speech section from 2.5 seconds to 5 seconds has been replaced, i.e., a bit “0” is detected intensively in this section, and these images are obtained through scanning in the downward and leftward directions.

The aforementioned method for determining the type of tampering is shown in a flowchart of FIG. 37. The tampering detection device according to the second or third embodiment extracts a tampered region from an acoustic signal that has been determined to be tampered with through the aforementioned tampering determination processing (step S801), and determines whether or not the number of sequences of a bit value “0” in the tampered region is equal to or greater than a predetermined threshold (step S802). If the tampering detection device determines that the number of such sequences is equal to or greater than the threshold (YES of step S802), it displays, on the display unit, an information-replaced tampering message indicating that the information-replaced tampering has been applied to the acoustic signal (step S803). On the other hand, if the tampering detection device determines that the number of such sequences is smaller than the threshold (NO of step S802), it displays, on the display unit, an information-added tampering message indicating that the information-added tampering has been applied to the acoustic signal (step S804).

In this way, the second and third embodiments enable not only the determination of whether or not tampering has been applied, but also the determination of the type of the tampering.

### Other Embodiments

While the embedding processing and the tampering detection processing for digital watermark data are realized by software in the above embodiments, the present invention is not limited in this way. For example, all or a part of such processing may be realized by a dedicated hardware circuit, such as a DSP (digital signal processor).

Furthermore, while digital watermark data is embedded in a monaural music signal serving as an original signal in the above embodiments, the present invention is not limited in this way. The digital watermark data may be embedded in both channels of a stereo music signal.

### INDUSTRIAL APPLICABILITY

A digital watermark detection device and a digital watermark detection method according to the present invention are respectively useful as, for example, a digital watermark detection device and a digital watermark detection method that detect digital watermark data embedded in acoustic signals of various music genres. Furthermore, a tampering detection device and a tampering detection method using a digital watermark according to the present invention are respectively useful as, for example, a tampering detection device and a tampering detection method that detect tampering with various acoustic signals.

### DESCRIPTION OF REFERENCE NUMERALS

1 digital watermark embedding device
11 CPU
12 ROM
13 RAM
14 signal input unit
15 signal output unit
16 hard disk drive
16A digital watermark embedding program
17 bus
101 frame processing unit
   102a first cochlear delay filter
102b second cochlear delay filter
103 filter selection unit
2 digital watermark detection device
21 CPU
22 ROM
23 RAM
24 signal input unit
25 hard disk drive
25A digital watermark detection program
26 bus
201 frame processing unit
202a, 202b transform unit
202a first chirp z-transform unit
202b second chirp z-transform unit
203 bit value detection unit
3 tampering detection device
301 embedded data detection unit
301a frame processing unit
301b first chirp z-transform unit
301c second chirp z-transform unit
301d bit value detection unit
302 digital watermark data generation unit
303 data comparison unit
304 tampering detection unit
4 digital watermark embedding device
5 tampering detection device

1. A digital watermark detection device comprising:
a cochlear delay characteristics estimation means for estimating cochlear delay characteristics simulated by a cochlear delay filter in a case where a digital watermark data embedding device has embedded digital watermark data in an acoustic signal, which is digital data, the digital watermark data embedding device applying phase modulation to the acoustic signal using the cochlear delay filter that simulates the cochlear delay characteristics and embedding the digital watermark data in the acoustic signal to which phase modulation has been applied; and
a digital watermark detection means for detecting the digital watermark data embedded in the acoustic signal based on the cochlear delay characteristics estimated by the cochlear delay characteristics estimation means.

2. The digital watermark detection device according to claim 1, wherein
the digital watermark data embedding device is configured to embed the digital watermark data by generating a plurality of different phase-modulated acoustic signals through application of phase modulation to acoustic signals using a plurality of different cochlear delay filters, selecting one acoustic signal from among the plurality of different phase-modulated acoustic signals in accordance with the digital watermark data, and merging selected acoustic signals,
the cochlear delay characteristics estimation means is configured to estimate a plurality of different cochlear delay characteristics simulated respectively by the plurality of different cochlear delay filters, and
the digital watermark detection means is configured to detect the digital watermark data by determining which one of the plurality of different cochlear delay filters has been used to apply phase modulation to the acoustic signals that have been embedded with the digital watermark data based on the plurality of different cochlear delay characteristics estimated by the cochlear delay characteristics estimation means.

3. The digital watermark detection device according to claim 1, wherein
the cochlear delay characteristics estimation means is configured to estimate the cochlear delay characteristics by estimating a zero of the cochlear delay filter.

4. The digital watermark detection device according to claim 3, wherein
the cochlear delay characteristics estimation means is configured to estimate the zero of the cochlear delay filter using chirp z-transform.

5. The digital watermark detection device according to claim 4, further comprising
an original signal acquisition means for acquiring the acoustic signal that has not been embedded with the digital watermark data yet by applying, to the acoustic signal that has been embedded with the digital watermark data, a filter having characteristics that are the inverse of the cochlear delay characteristics estimated by the cochlear delay characteristics estimation means.

6. The digital watermark detection device according to claim 2, further comprising
an original signal acquisition means for acquiring the acoustic signal that has not been embedded with the digital watermark data yet by applying an inverse filter for the cochlear delay filter that has been determined by the digital watermark detection means to have been used to apply phase modulation to the acoustic signal that has been embedded with the digital watermark data, to that acoustic signal that has been embedded with the digital watermark data.

7. A digital watermark detection method comprising:
(a) a step of estimating cochlear delay characteristics simulated by a cochlear delay filter in a case where a digital watermark data embedding device has embedded digital watermark data in an acoustic signal, which is digital data, the digital watermark data embedding device applying phase modulation to the acoustic signal using the cochlear delay filter that simulates the cochlear delay characteristics and embedding the digital watermark data in the acoustic signal to which phase modulation has been applied; and
(b) a step of detecting the digital watermark data embedded in the acoustic signal based on the estimated cochlear delay characteristics.

8. The digital watermark detection method according to claim 7, wherein
the digital watermark data embedding device is configured to embed the digital watermark data by generating a plurality of different phase-modulated acoustic signals through application of phase modulation to acoustic signals using a plurality of different cochlear delay filters, selecting one acoustic signal from among the plurality of different phase-modulated acoustic signals in accordance with the digital watermark data, and merging selected acoustic signals,
in step (a), a plurality of different cochlear delay characteristics simulated respectively by the plurality of different cochlear delay filters are estimated, and
in step (b), the digital watermark data is detected by determining which one of the plurality of different cochlear delay filters has been used to apply phase modulation to the acoustic signals that have been embedded with the digital watermark data based on the plurality of different cochlear delay characteristics estimated in step (a).

9. The digital watermark detection method according to claim 8, wherein
in step (a), the cochlear delay characteristics are estimated by estimating a zero of the cochlear delay filter.

10. The digital watermark detection method according to claim 9, wherein
in step (a), the zero of the cochlear delay filter is estimated using chirp z-transform.

11. A tampering detection device that makes use of a digital watermark, wherein
the tampering detection device detects tampering with an acoustic signal, which is digital data, after digital watermark data has been embedded in the acoustic signal by applying phase modulation to the acoustic signal using a cochlear delay filter that simulates cochlear delay characteristics, and comprises:
an acoustic signal acquisition means for acquiring the acoustic signal from outside;
a cochlear delay characteristics estimation means for estimating the cochlear delay characteristics simulated by the cochlear delay filter;
an embedded data detection means for detecting embedded data that has been embedded in the acoustic signal acquired by the acoustic signal acquisition means based on the cochlear delay characteristics estimated by the cochlear delay characteristics estimation means;
a comparison means for comparing the embedded data detected by the embedded data detection means with the digital watermark data; and
a tampering determination means for determining whether or not the acoustic signal has been tampered with based on a result of comparison by the comparison means.

12. A tampering detection method that makes use of a digital watermark, wherein
the tampering detection method detects tampering with an acoustic signal, which is digital data, after digital watermark data has been embedded in the acoustic signal by applying phase modulation to the acoustic signal using a cochlear delay filter that simulates cochlear delay characteristics, and comprises:
(a) a step of acquiring the acoustic signal from outside;
(b) a step of estimating the cochlear delay characteristics simulated by the cochlear delay filter;
(c) a step of detecting embedded data that has been embedded in the acquired acoustic signal based on the estimated cochlear delay characteristics;
(d) a step of comparing the detected embedded data with the digital watermark data; and
(e) a step of determining whether or not the acoustic signal has been tampered with based on a result of comparison.

13. The digital watermark detection device according to claim 2, wherein
the cochlear delay characteristics estimation means is configured to estimate the cochlear delay characteristics by estimating a zero of the cochlear delay filter.

14. The digital watermark detection device according to claim 13, wherein
the cochlear delay characteristics estimation means is configured to estimate the zero of the cochlear delay filter using chirp z-transform.

15. The digital watermark detection device according to claim 13, further comprising
an original signal acquisition means for acquiring the acoustic signal that has not been embedded with the digital watermark data yet by applying, to the acoustic signal that has been embedded with the digital watermark data, a filter having characteristics that are the inverse of the cochlear delay characteristics estimated by the cochlear delay characteristics estimation means.
